(19) United States
(12) Patent Application Publication
(10) Pub. No.: US 2011/0154686 A1
(43) Pub. Date: Jun. 30, 2011

(54) APPARATUS AND METHOD FOR TREATING A COMMODITY

(75) Inventor: Vincent P. TIPPMANN, Fort Wayne, IN (US)

(73) Assignee: SUREWOOD LUMBER, LLC, Fort Wayne, IN (US)

(21) Appl. No.: 12/958,170

(22) Filed: Dec. 1, 2010

Related U.S. Application Data
(60) Provisional application No. 61/265,561, filed on Dec. 1, 2009.

(51) Int. Cl. F26B 3/04; F26B 21/06; F26B 21/08; F26B 21/10

(52) U.S. Cl. 34/475; 34/467; 34/72; 34/543

(57) ABSTRACT

A method and apparatus for treating a commodity includes providing a sealed enclosure. A commodity is arranged in a plurality of layers spaced apart to provide ventilation areas between the layers. The commodity is further arranged in a plurality of rows having a space formed therebetween. A cover is positioned on a top surface and an exposed end surface of the rows or an exposed surface of an air handler to provide a seal. The air handler is positioned in communication with the space between the rows so as to move air along the space and through the ventilation areas, such that an even flow of air is achieved over the commodity. A catalytic heater/converter is provided for burning unburnt fuel and for depleting oxygen from the sealed enclosure during the heating of the commodity. A controller controls the air flowing through the ventilation areas and over the commodity.

### CROSS-REFERENCE TO RELATED APPLICATIONS

The present application claims priority under 35 USC 119(e) to Provisional Patent Application No. 61/265,561 filed on Dec. 1, 2009 the entire contents of which are hereby incorporated by reference.

### BACKGROUND OF THE INVENTION

1. Field of the Invention

The present invention relates generally to methods and apparatus for treating a commodity. More specifically, to a method and apparatus for treating wood products for the purpose of preserving the wood without the use of chemicals.

2. Description of Background Art

Heat treated wood and lumber is a relatively new, environmentally-friendly product. Wood that has been heat treated does not contain chemicals or compounds typically present in chemically treated lumber. Thus, the heat treated wood can be used in a wider variety of applications and with less concern for contact with humans, pets and other animals, ground water, plants and other elements of the environment.

When wood is exposed to high temperatures (i.e., 200 degrees centigrade or more), the properties of the wood change in relatively significant ways. Saps inside the wood are changed into a form not digestible by insects. By heating the wood to a high temperature, the moisture in the wood is reduced to 4% which will not support fungus, mold or bacteria. All types of woods can be heat treated. The stability of heat treated wood is enhanced, as compared to untreated forms, and the wood is naturally darkened so that painting and/or staining is, in many instances, unnecessary.

### SUMMARY AND OBJECTS OF THE INVENTION

It is an object of an embodiment of the present invention to provide a method and apparatus for treating a commodity, such as lumber or wood products, by pulling heated air through and/or around a stack of commodity that may be stacked on pallets or carts.

Another object of the present invention is to provide a method and apparatus for treating a commodity, such as lumber or wood products, by circulating heated air through and/or around layers of the commodity so as to evenly and efficiently heat treat the commodity.

It is a further object of an embodiment of the present invention to provide a plurality of pallets or layered stacks of the commodity that are positioned in two rows with a space formed therebetween. A cover is positioned over at least a top surface and an exposed end surface of the commodities or an exposed surface of an air handler to form a plenum. The air handler is positioned to pull air from between the plurality of pallets and through the ventilation layers formed adjacent to the adjoining commodities and along the length of the space formed between the two rows for achieving an even flow of air for treating the commodity positioned on the pallets or in the layered stacks.

Other objects of an embodiment of the present invention are achieved by providing a method and apparatus for treating a commodity, such as lumber or wood products, by positioning the lumber or wood in a plurality of layers spaced apart so as to provide ventilation spaces therebetween. The commodity may be positioned in at least two rows with a space formed therebetween. A cover is positioned over at least a top surface and an exposed end surface of the row or an exposed surface of the air handler so as to provide a seal along the top surface and the end surface or an exposed surface of the air handler. The air handler is positioned in communication with the space between the rows so as to move air along the space and through the ventilation areas between the layers of the commodity. A source of heat is provided to allow for elevation of the temperature of the air circulated by the air handler. Unburnt fuel and oxygen are depleted from the heated air circulated by the air handler by use of a catalytic heater/converter so as to prevent combustion of the wood.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic view illustrating a heating unit for thermally processing a commodity, such as wood or lumber, within a sealed environment;

FIG. 2 is a top plan view of a commodity disposed within the heating unit in rows with an air handler being disposed substantially in a central location relative to the commodity and with the catalytic heater/converter being removed for greater visibility of the air handler; and

FIG. 3 is a side elevational view of a commodity positioned within the heating unit with an air handler being disposed substantially in a central location relative to the commodity.

### DETAILED DESCRIPTION OF THE PREFERRED EMBODIMENTS

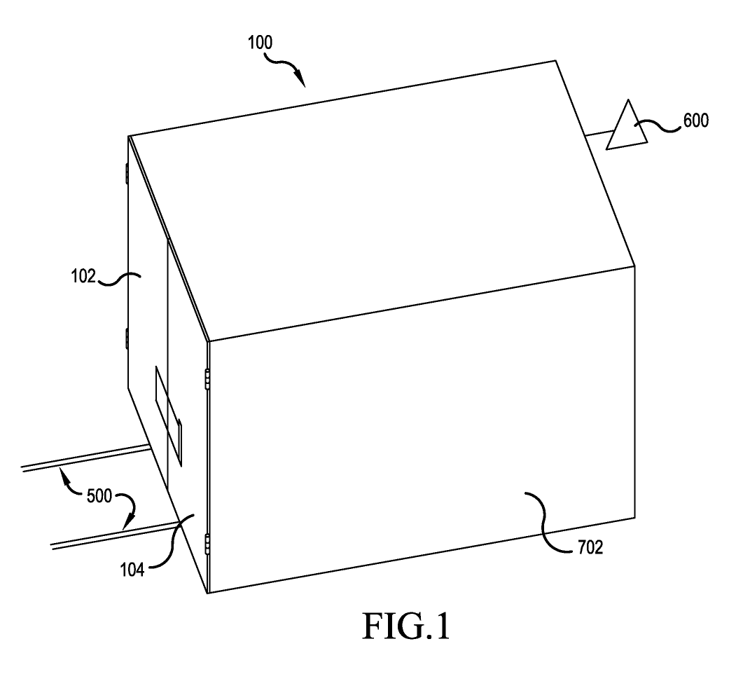

As illustrated in FIGS. 1-3, heating unit 100 is provided for thermally processing a commodity, such as wood or lumber. The heating unit 100 is a kiln or closed oven for heating the wood or lumber in a controlled environment to permit the wood or lumber to achieve an increased resistance to bacteriological decay, mold, rot, insect attack, etc. By thermally processing the commodity, a product with reduced water absorption and increased dimensional stability is achieved. Wood or lumber treated according to the present invention has a moisture content of approximately 4% as compared to conventional wood or lumber used for an outside deck that has a moisture content of approximately 17%.

In the embodiment illustrated in FIGS. 1-3, the reduction in physical mass and mechanical strength as a function of higher temperature heating can be minimized if the process is carried out in an oxygen depleted atmosphere. The present invention limits the exothermic oxidation processes that occur at the critical heating temperatures. A catalytic heater/converter 400 is provided to burn any unburnt fuel in the heating unit 100 and for removing oxygen from the heating unit 100 as the wood or lumber is heated to a processing temperature of 175 to 235 degrees C. A high quality wood or lumber product is achieved by transferring the heat evenly to prevent the wood or lumber disposed on the outside of a stack from getting too hot and damaging the commodity. Wood or lumber treated according to the present invention does not experience warping after treatment in view of the fact that the temperature of the air being pulled through the stack of wood or lumber does not drop dramatically as the air is pulled through the stack. The exact temperature is dependent on the species of the wood or lumber and is application dependant.

In addition, a reduction in physical mass and mechanical strength as a function of hydrolysis caused by acetic and formic acids being liberated during the heating process also occurs.

Further, dimensional stability is also of key importance. As wood or lumber is heated non-uniformly, stress risers result. The stresses cause surface and internal checking and cracking. The use of a high velocity, turbulent air flow is provided between the boards stacked in the heating unit 100 to evenly distribute the heat.

An electric heater or a boiler is operatively connected to provide heat to the heating unit 100. The boiler may be heated by using propane gas or oil, raw wood products or electricity. The present invention provides for a maximum utilization of various ways to provide heat to the heating unit 100 to enable a user to use various sources of fuel. The heating unit 100 is equipped with a steam boiler for developing raw steam or pressurized steam to raise the temperature up to 105 degrees C.

As illustrated in FIG. 1, rails 500 may be utilized for loading and unloading a commodity such as wood or lumber into the heating unit 100. In addition, manually loading or any other type of use of a loader such as a fork-lift is acceptable to permit the commodity to be loaded into the heating unit 100 and unloaded from the heating unit 100.

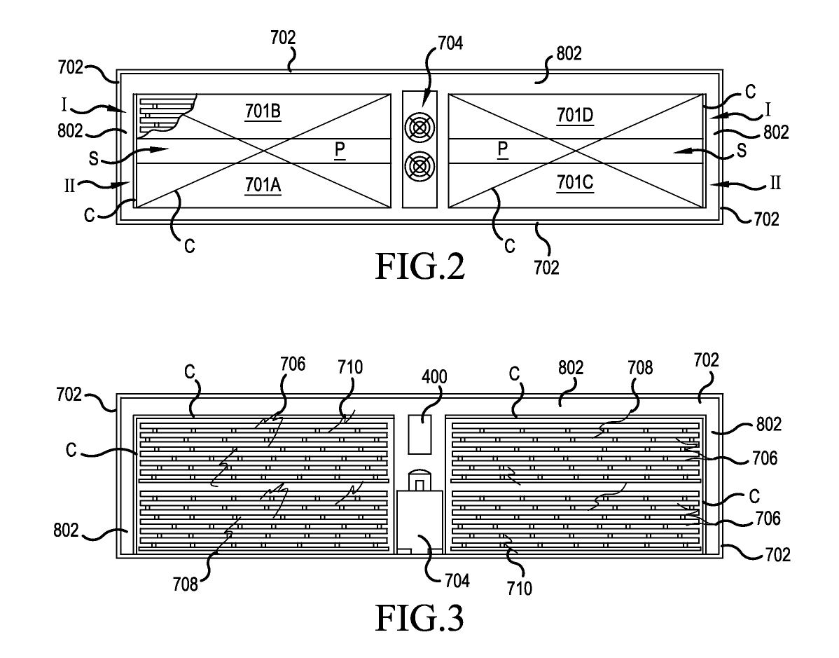

A catalytic heater/converter 400 is used to burn unburnt fuel and for depleting oxygen from the sealed environment of the heating unit 100. As the wood or lumber is heated to the critical processing temperature of approximately 175 to 235 degrees C. (depending upon the wood species and the application), the commodity looses mass due to the pyrolysis reactions and exothermic oxidation reactions. By reducing the oxygen, the pyrolysis and the exothermic oxidation reactions are minimized. By reducing these reactions the present invention maintains more of the mechanical properties of the wood or lumber. The use of the catalytic heater/converter also reacts to burn any combustible gases which are liberated from the wood being processed in the heating unit 100. As illustrated in FIG. 2, the catalytic heater/converter 400 may be positioned above an air handler 704. It is to be noted that the catalytic heater/converter 400 may be positioned at any location within the heating unit 100 to produce the desired result of burning the unburnt fuel and depleting the oxygen.

The present invention utilizes a turbulent flow of air that is produced by the air handler 704 which is a high velocity fan system to circulate air within the heating unit 100 to produce turbulent air flow between the boards stacked in the heating unit 100. This reduces the mechanical stress in the wood to minimize physical warping, cracking, checking, etc. A system for drawing air to the center of the heating unit 100 and recirculating the air to a space 802 between an enclosure 702 and the stacks of commodities is used.

An integrated control system 600 is included for measuring the temperature of the heating unit 100, product temperature, product moisture content, oxygen levels in the heating unit 100, internal pressure in the heating unit 100, relative humidity in the heating unit 100, CO content in the heating unit 100, boiler conditions, safety conditions, etc. Adjustments to the heating unit 100 and operating variables will be carried out by the control system 600.

FIG. 2 is a top plan view of stacks of a commodity, such as wood or lumber for loading and unloading into the heating unit 100. The heating unit 100 is formed by the enclosure 702. The enclosure 702 may be formed of various materials, including steel. Access to the interior of the heating unit 100 may be provided on one or both ends, or one or both sides. In the embodiment illustrated in FIG. 1, hinged doors 102, 104 may be opened to allow the commodity to be placed into and removed from enclosure 702. In one embodiment, enclosure 702 is similar to (or may actually be) a shipping container of the type used to transport goods by container ship, rail or truck. In such instances, hinged doors are typically provided on one end, as is well known.

With further reference to FIG. 2, there are illustratively shown a plurality of stacks 701A, 701B, 701C and 701D of lumber arranged in two rows I and II with a space S formed therebetween. The term space means that both stacks are substantially equally disposed relative to each other to form a continuous space therebetween. As illustrated in FIG. 2, a space 802 is provided between the enclosure 702 and the stacks 701A, 701B, 701C and 701D to ensure a flow of air around the stacks.

In an embodiment of the present invention, a plurality of stacks 701C and 701D of lumber may be arranged in two rows I and II with a space S formed therebetween. The air handler 704 may be positioned an end of the two rows with a cover positioned over the exposed surface of the air handler 704. In addition, the cover C would be positioned on the top surface and an exposed end surface of the stacks. The air handler 704 would pull heated air through ventilation areas between the layers of the lumber and exhaust the heated air into the space 802 provided between the enclosure 702 and the stacks 701C and 701D to ensure a flow of air around the stacks.

As illustrated in FIGS. 2 and 3, a cover C may be positioned on at least a top surface and an exposed end surface of the commodities or an exposed surface of the air handler disposed within the heating unit 100 for sealing the two rows along the top surface and the exposed end surface or the exposed surface of the air handler. Cover C may extend to other surfaces, as well, in order to direct air flow through the stacks of the commodity. Cover C may, for example, be a flexible metal plate positioned on the top surface and an exposed end surface of the commodities that is sucked up tight to make a seal as air is pulled through the commodities (as described more fully below) and along the space formed between the rows. If only two stacks are used, a cover would be positioned over the exposed surface of the air handler.

In FIG. 2, a portion of cover C on the top of the left-hand side of stack 701B has been broken away to reveal the commodity (i.e., lumber in the form of boards 706.)

A plenum P is formed between the two rows I and II, as illustrated in FIG. 2. With reference to FIG. 3, boards 706 are stacked in layers with gaps created by spacers 708 positioned along the lengths of vertically adjacent boards. Spacers 708 create ventilation areas 710 in the form of elongated openings between adjacent boards. The presence of ventilation areas 710 allows air to flow freely over the top and bottom surfaces of boards 706.

Air handler 704 is positioned, in the embodiment of FIGS. 2 and 3, between stacks 701A and 701B on one side and 701C and 701D on the other. Air is drawn through ventilation areas 710 through the stacks and along space S and through plenum P to air handler 704. The space 802 between the enclosure 702 and the stacks also ensures a flow of heated air as the air handler 704 pulls the heated air along the space S and through the plenum P.

The air handler 704 may exhaust air pulled through plenums P into the heating unit 100 for thermally treating the wood or lumber in the heating unit 100. Openings along the sides of the stacks are provided to allow the air to circulate, flowing from the sides of the stacks toward space S and through plenum P to air handler 704. In such embodiments, the environment inside the heating unit 100 is controlled, both in terms of temperature and the composition of the moisture, the unburnt gases and oxygen. The temperature of the air (or atmosphere) surrounding and circulating through enclosure 702 will vary between ambient or “room” temperature on the low side during the loading of the heating units to 175 to 235 degrees C. or more on the high side. At high temperatures, the percentage of oxygen in the heating unit 100 is reduced by use of the catalytic heater/converter 400 to burn unburnt fuel and to prevent combustion of the wood.

In other embodiments, the exhaust of air handler 704 is directed through passageways 802 formed on the sides of the stacks so as to form a closed air circulating system. In such embodiments, the temperature of the circulating air is controlled by heaters (not shown). The composition of the air (i.e., oxygen content, moisture content, etc.) may also be controlled to achieve proper heat treatment of the commodity.

The embodiment illustrated in FIGS. 2 and 3 assures relatively even and consistent turbulent air flow over all surfaces of and through all layers of the commodity. The apparatus is designed to direct air flow perpendicularly to space S and plenum P across the shorter dimensions of rows 701A, 701B, 701C and 701D, and then parallel to the rows along space S and plenum P to air handler 704. This flow pattern assures that conditioned air does not flow for long distances adjacent the commodity (e.g., along the lengths of boards 706), so that the temperature of the air will remain relatively constant along the surface of any particular board, and along the surfaces of adjacent boards. This would be less likely to occur if, for example, air flows from one end of rows I and II to the other end, so as to pass lengthwise over boards 706.

Another mechanism for assuring more even and uniform temperature control (i.e., heating and cooling) of the commodity is to control the rate of increase and decrease of the air temperature. Increasing or decreasing the air temperature incrementally (i.e., a few degrees at a time) affords time for the temperature of the commodity to increase or decrease in correspondence with the increases or decreases in air temperature. This facilitates, for example, relatively uniform treatment of a board located on an end of stacks 701A, 701B, 701C or 701D, as compared to a board in the same layer on an opposing end of the stack.

In a process of thermally treating wood or lumber, boards are stacked with a predetermined space between the boards. The boards are positioned on a trolley system for using the rails 500 for loading the boards into the heating unit 100.

At the beginning of the heating cycle, the heating unit 100 is heated by injecting raw saturated steam into the heating unit 100 with a turbulent air flow system. In addition, heaters connected to the heating unit 100 is actuated for providing additional heat. The steam injection provides a quick transfer of heat by condensing steam onto the wood surface as well as the moisture laden atmosphere helping to reduce the surface stress of wood. The catalytic heater/converter 400 is used to deplete the oxygen in the heating unit 100. The use of steam is not used for depleting the oxygen.

The temperature differential between the core of the commodity and the air is to be held constant at about 10 to 30 degrees C. This temperature differential will be programmable and will use multiple sensors arranged throughout the heating unit 100. There is a desire to raise the inner core temperature of the wood as rapidly as possible. However, the temperature differential between the air and the wood should not exceed the programmed value of 10 to 30 degrees C.

During the drying phase, the inner core temperature of the wood is raised to a first plateau of between 90 to 130 degrees C. Raw saturated steam initially injected into the heating unit 100 will be terminated and changed to a dry superheated steam. The drying phase is intended to permit the internal water in the wood to evaporate. The amount of time that the system is continued at the drying phase will depend on time, internal moisture content of the wood and relative humidity of the atmosphere in the heating unit 100. Venting to atmosphere through pressure controlling dampers will be provided.

During the treatment phase, after the drying phase has taken place, the temperature of the oven should be increased to the final treatment value. During this step, evacuation of the oxygen from the inside of the heating unit 100 should take place. At about 140 degrees C., the catalytic heater/converter 400 combination is turned on. This will burn unburnt fuel in the heating unit 100 to lower the oxygen level to 1 to 3 percent. The oxygen level is monitored and the catalytic heater/converter is turned off when the oxygen level is sufficiently low. The source of heat may be the boiler which can be switched from dumping raw steam into the heating unit 100 to a higher pressure boiler with a heat exchanger in the air stream. The source of the heat may be electric heating coils.

The pressure in the heating unit 100 should be maintained as slightly positive and above atmosphere to prevent any oxygen from entering the heating unit 100 through leaks.

The thermal treatment is continued for a predetermined time to permit the attainment of the final temperature by using the heating system for the duration of the treatment process. Oxygen depletion is maintained in this environment. The oxygen level should be monitored to assure the oxygen level does not rise. If the oxygen level rises, the catalytic heater/converter system is used to lower the oxygen level.

The temperature may be lowered by a combination of raw steam injection and water mist. Through the use of water mist and steam, the cooling ramp differential temperature is maintained between the wood product core and the turbulent air flow around the wood product. The set point differential temperature is a programmable value optimized on a per species basis to optimize product quality.

Although the present invention has been described with reference to particular means, materials and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A method for treating a commodity, comprising:
providing a sealed enclosure;
arranging a commodity in the enclosure in a plurality of layers, said layers being spaced apart to form ventilation areas therebetween;
positioning the commodity in at least two rows with a space formed therebetween;
heating the commodity;
positioning a cover on at least a top surface and an exposed end surface of said rows or an exposed surface of an air handler so as to provide a seal along said surfaces;
positioning the air handler in communication with the space between the rows so as to move air along the space and through the ventilation areas between the layers of the commodity such that an even flow of air is achieved through the ventilation areas and along the rows for evenly treating the commodity; and
providing a catalytic heater/converter for burning unburnt fuel and for depleting oxygen from the sealed enclosure during the heating of the commodity.

2. The method of claim 1, further comprising the step of positioning the ventilation areas in the layers of the commodity wherein air flows over the commodity in a direction which is substantially perpendicular to the space, and then along the space to the air handler in a direction which is substantially parallel to the commodity.

3. The method of claim 1, further comprising the step of providing passageways formed along sides of the enclosure to receive an exhaust flow from the air handler so as to form a closed air circulating system.

4. The method of claim 1, further comprising the step of conditioning the air flowing through the ventilation areas and along the space.

5. The method of claim 4, wherein the step of conditioning the air comprises at least one of increasing a temperature of the air, decreasing a temperature of the air, controlling moisture content of the air, and controlling the amount of oxygen and unburnt fuel in the air.

6. The method of claim 1, further comprising the step of providing a heat source to heat the air being moved through the ventilation areas and along the space.

7. The method of claim 6, further comprising the step of removing at least a substantial portion of oxygen from the air so as to prevent combustion of the commodity.

8. The method of claim 6, wherein said step of providing a heat source to heat the air comprises the step of gradually heating the air in controlled increments so as to control a rate of temperature increase of the commodity.

9. The method of claim 1, wherein said commodity is wood and the method comprises a method of heat treating the wood so as to cause internal changes in the wood to enhance properties thereof.

10. An apparatus for treating a commodity, comprising:
a sealed enclosure;
a plurality of layers of a commodity spaced apart so as to form ventilation areas between adjacent layers, said commodity being further arranged in a plurality of rows with a space formed therebetween;
a cover positioned on at least a top surface and an exposed end surface of the commodity or an exposed surface of an air handler for sealing the plurality of rows along said surfaces;
a plenum formed between said rows to facilitate a flow of air over the commodity;
a heater for heating the enclosure;
said air handler being positioned to pull air through the ventilation areas and along the space and through the plenum formed between the rows;
wherein a relatively turbulent flow of air is achieved through the ventilation areas and between the layers of the commodity positioned in the enclosure; and
a catalytic heater/converter for burning unburnt fuel and for depleting oxygen from the sealed enclosure during the heating of the commodity.

11. The apparatus according to claim 10, further comprising a controller for controlling the air flowing through the ventilation areas and over the commodity.

12. The apparatus according to claim 11, wherein the conditioner includes at least one means for increasing the air temperature, means for decreasing the air temperature, means for controlling moisture content of the air and means for controlling oxygen and unburnt fuel in the air.

13. The apparatus according to claim 10, wherein the commodity is wood.

14. The apparatus according to claim 10, wherein the at least one air handler is positioned approximately midway between the rows of the commodity so as to turbulently pull air through the ventilation areas and along the space formed between the rows.

15. The apparatus according to claim 10, wherein the at least one air handler is positioned at an end of the rows of the commodity so as to turbulently pull air through the ventilation areas and along the space formed between the rows.

16. The apparatus according to claim 10, wherein said enclosure includes a passageway formed between the enclosure and the commodity to receive a flow of air from the air handler.
